(19) United States
(12) Patent Application Publication
(10) Pub. No.: US 2012/0093546 A1
(43) Pub. Date: Apr. 19, 2012

(54) FIXING DEVICE AND IMAGE FORMING APPARATUS

(75) Inventors: Hideaki OHARA, Kanagawa (JP); Kazuyoshi ITOH, Kanagawa (JP); Yasuhiro UEHARA, Kanagawa (JP)

(73) Assignee: FUJI XEROX CO., LTD., Tokyo (JP)

(21) Appl. No.: 13/156,806

(22) Filed: Jun. 9, 2011

(30) Foreign Application Priority Data
Oct. 13, 2010 (JP) 2010-230854

(51) Int. Cl. G03G 15/20

(52) U.S. Cl. 399/329

(57) ABSTRACT

A fixing device includes a belt-like member provided so as to circularly move, a forming member disposed so as to come into contact with an outer peripheral surface of the belt-like member and forms a pressing portion, where a recording material is pressed, between the belt-like member and the forming member, a contact member that comes into contact with the belt-like member, a heating member positioned on a side more distant from the belt-like member as compared to the contact member, and heats the contact member, a receiving member positioned on a side more distant from the belt-like member as compared to the heating member, and receives heat from the heating member, and a heat transfer portion provided so as to be connected to the receiving member and the contact member, and transfers heat to the contact member from the receiving member.

### CROSS-REFERENCE TO RELATED APPLICATION

This application is based on and claims priority under 35 USC 119 from Japanese Patent Application No. 2010-230854 filed on Oct. 13, 2010.

### BACKGROUND

### Technical Field

The present invention relates to a fixing device and an image forming apparatus.

### SUMMARY

According to an aspect of the invention, there is provided a fixing device including:

a belt-like member that is provided so as to circularly move;

a forming member that is disposed so as to come into contact with an outer peripheral surface of the belt-like member and forms a pressing portion, where a recording material is pressed, between the belt-like member and the forming member;

a contact member that comes into contact with the belt-like member;

a heating member that is positioned on a side more distant from the belt-like member as compared to the contact member, and heats the contact member;

a receiving member that is positioned on a side more distant from the belt-like member as compared to the heating member, and receives heat from the heating member; and

a heat transfer portion that is provided so as to be connected to the receiving member and the contact member, and transfers heat to the contact member from the receiving member.

### BRIEF DESCRIPTION OF THE DRAWINGS

Exemplary embodiments of the present invention will be described in detail based on the following figures, wherein:

FIG. 1 is a view showing an example of an image forming apparatus to which a fixing device is applied;

FIG. 2 is a view showing the structure of a fixing unit;

FIG. 3 is a view showing the structure of the fixing unit;

FIG. 4 is a view illustrating a temperature-sensitive magnetic member;

FIG. 5 is a view illustrating a heating element;

FIG. 6 is a view showing the cross-sectional structure of a fixing belt;

FIG. 7A is a side view of an end cap member, and FIG. 7B is a plan view of the end cap member seen from the direction of an arrow VIIB;

FIG. 8 is a cross-sectional view illustrating the structure of an IH heater;

FIG. 9 is a view illustrating the state of magnetic field lines when the temperature of the fixing belt is in a temperature range not higher than a magnetic permeability change start temperature;

FIG. 10 is a view schematically showing temperature distribution of the fixing belt in a width direction when small-sized sheets successively pass;

FIG. 11 is a view illustrating the state of magnetic field lines when the temperature of the fixing belt in a non-sheet-passing area is in a temperature range exceeding a magnetic permeability change start temperature; and

FIGS. 12A and 12B are views showing slits that are formed at the temperature-sensitive magnetic member.

### DETAILED DESCRIPTION

Exemplary embodiments of the invention will be described in detail below with reference to accompanying drawings.

<Description of Image Forming Apparatus>

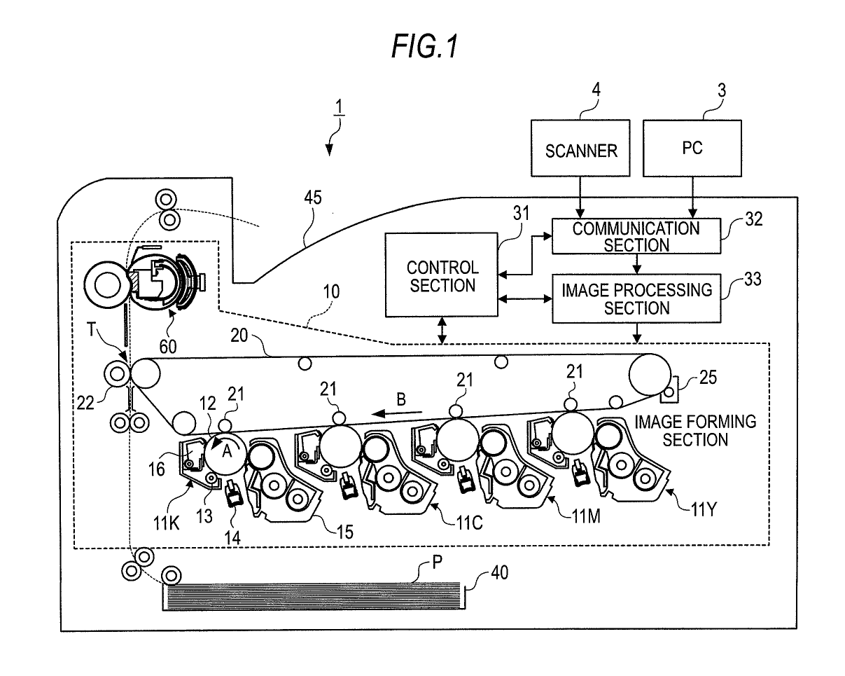

FIG. 1 is a view showing an example of an image forming apparatus to which a fixing device according to this exemplary embodiment is applied.

An image forming apparatus 1 shown in FIG. 1 is a so-called tandem type color printer. The image forming apparatus 1 includes an image forming section 10 that forms images on a sheet P on the basis of image data, and a control section 31 that controls the operation of the entire image forming apparatus 1. In addition, the image forming apparatus 1 includes a communication section 32 and an image processing section 33. The communication section 32 receives image data through the communication with, for example, a personal computer (PC) 3, an image reading device (scanner) 4, or the like. The image processing section 33 performs predetermined image processing on the image data that is received by the communication section 32.

The image forming section 10 includes four image forming units 11Y, 11M, 11C, and 11K (which are collectively referred to as “image forming units 11”) that are disposed in parallel at regular intervals. Each of the image forming units 11 includes a photoreceptor drum 12, a charger 13, an LED (Light Emitting Diode) print head 14, a developing unit 15, and a drum cleaner 16. The photoreceptor drum 12 forms an electrostatic latent image and holds a toner image. The charger 13 uniformly charges the surface of the photoreceptor drum 12 with a predetermined electric potential. The LED print head 14 exposes the photoreceptor drum 12, which is charged by the charger 13, on the basis of the data of each color image. The developing unit 15 develops the electrostatic latent image formed on the photoreceptor drum 12. The drum cleaner 16 cleans the surface of the photoreceptor drum 12 after transfer. The image forming units 11 have the same structure except for toner stored in the developing units 15, and form yellow (Y), magenta (M), cyan (C), and black (K) toner images, respectively.

Further, the image forming section 10 includes an intermediate transfer belt 20 and primary transfer rollers 21. The respective color toner images, which are formed on the photoreceptor drums 12 of the respective image forming units 11, are multiply transferred to the intermediate transfer belt 20. The primary transfer rollers 21 sequentially transfer (primarily transfer) the respective color toner images, which are formed by the respective image forming units 11, to the intermediate transfer belt 20. Furthermore, the image forming section 10 includes a secondary transfer roller 22 and a fixing unit 60 (an example of a fixing device). The secondary transfer roller 22 collectively transfers (secondarily transfers) the respective color toner images, which are superimposed on and transferred to the intermediate transfer belt 20, to a sheet P that is a recording material (recording sheet). The fixing unit 60 fixes the respective color toner images, which have been secondarily transferred, to the sheet P.

In the image forming apparatus 1 according to this exemplary embodiment, image forming processing, which is performed through the following processes, is performed under the operation control that is performed by the control section 31. That is, after the image data sent from the PC 3 or the scanner 4 are received by the communication section 32 and are subjected to predetermined image processing by the image processing section 33, the image data is changed to respective color image data and sent to the image forming units 11. Further, in the image forming unit 11K that forms, for example, a black (K) toner image, the photoreceptor drum 12 is uniformly charged with a predetermined electric potential by the charger 13 while being rotated in the direction of an arrow A, and the LED print head 14 scans and exposes the photoreceptor drum 12 on the basis of black image data sent from the image processing section 33. Accordingly, an electrostatic latent image, which corresponds to a black image, is formed on the photoreceptor drum 12. The black electrostatic latent image, which is formed on the photoreceptor drum 12, is developed by the developing unit 15, so that a black toner image is formed on the photoreceptor drum 12. Likewise, yellow (Y), magenta (M), and cyan (C) toner images are also formed in the image forming units 11Y, 11M, and 11C, respectively.

The color toner images, which are formed on the photoreceptor drums 12 of the respective image forming units 11, are sequentially electrostatically transferred (primarily transferred) to the intermediate transfer belt 20, which is moved in the direction of an arrow B, by the primary transfer rollers 21. Accordingly, a superimposed toner image where the respective color toners are superimposed is formed on the intermediate transfer belt 20. Further, as the intermediate transfer belt 20 is moved, the superimposed toner image formed on the intermediate transfer belt 20 is conveyed to an area (secondary transfer portion T) where the secondary transfer roller 22 is disposed. When the superimposed toner image is conveyed to the secondary transfer portion T, a sheet P is fed to the secondary transfer portion T from a sheet holding section 40 so as to match the timing where the superimposed toner image is conveyed to the secondary transfer portion T. Furthermore, the superimposed toner image is collectively electrostatically transferred (secondarily transferred) to the conveyed sheet P at the secondary transfer portion T by a transfer electric field that is formed by the secondary transfer rollers 22.

After that, the sheet P to which the superimposed toner image has been electrostatically transferred is conveyed up to the fixing unit 60. Heat and pressure are applied to the toner image, which is formed on the sheet P conveyed to the fixing unit 60, by the fixing unit 60, so that the toner image is fixed to the sheet P. Then, the sheet P to which the toner image has been fixed is conveyed to a sheet stacking portion 45 that is provided at an ejection section of the image forming apparatus 1. Meanwhile, toner that adheres to the photoreceptor drums 12 after primary transfer (primary transfer residual toner) and toner that adheres to the intermediate transfer belt 20 after secondary transfer (secondary transfer residual toner) are removed by the drum cleaners 16 and the belt cleaner 25, respectively. In this way, image forming processing in the image forming apparatus 1 is repeated for several cycles that correspond to the number of sheets to be printed.

<Description of Structure of Fixing Unit>

Next, the fixing unit 60 according to this exemplary embodiment will be described.

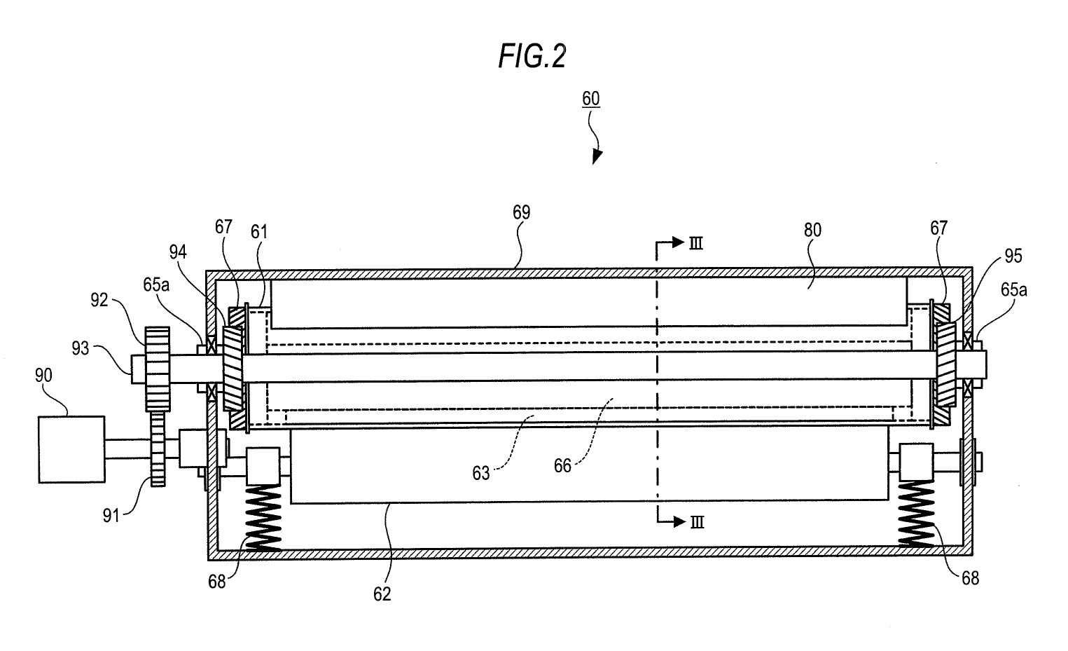

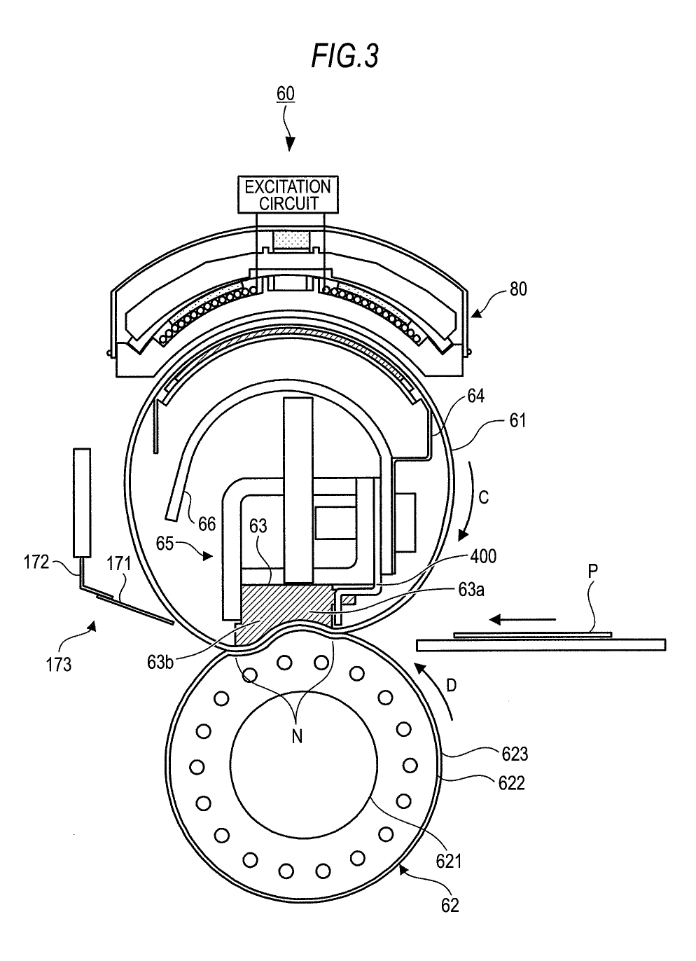

FIGS. 2 and 3 are views showing the structure of the fixing unit 60 according to this exemplary embodiment. FIG. 2 is a front view and FIG. 3 is a cross-sectional view taken along a line III-III of FIG. 2.

First, as shown in FIG. 3 that is a cross-sectional view, the fixing unit 60 includes an IH (Induction Heating) heater 80 that generates an AC magnetic field; a fixing belt 61 (an example of a belt-like member) that is provided so as to circularly move, is heated by electromagnetic induction with the IH heater 80, and fixes a toner image; a pressure roller 62 that is disposed so as to come into contact with the outer peripheral surface of the fixing belt 61 and presses the fixing belt 61 to the inside of the fixing belt 61; and a pressing pad 63 that is pressed by the pressure roller 62 with the fixing belt 61 interposed therebetween. Further, the fixing unit 60 includes a holder 65 that is disposed on the inner side of the pressing pad 63 as compared to the fixing belt 61 and supports a member such as the pressing pad 63, a temperature-sensitive magnetic member 64 that forms magnetic paths by inducing the AC magnetic field generated by the IH heater 80, an induction member 66 that induces magnetic field lines passing through the temperature-sensitive magnetic member 64, and an auxiliary separating member 173 that assists in separating the sheet P from the fixing belt 61.

<Description of Fixing Belt>

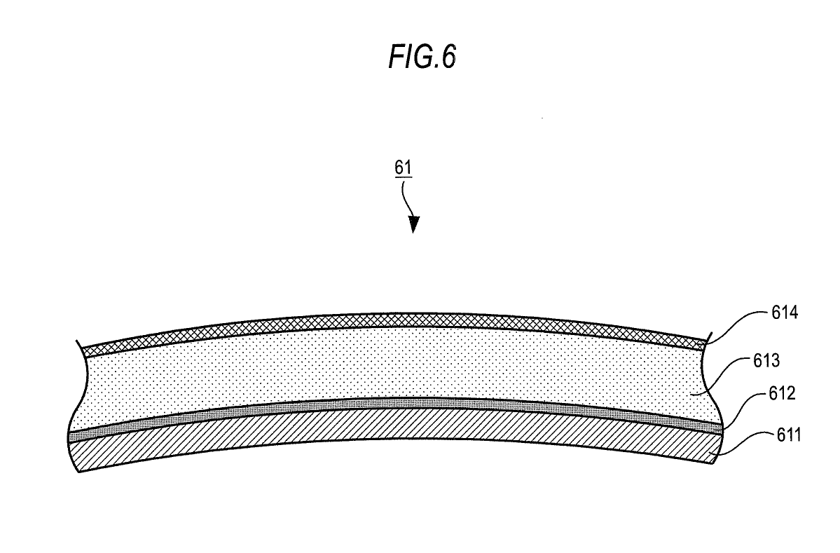

The fixing belt 61 is formed of an endless belt member of which an original shape is a cylindrical shape. When the fixing belt retains its original shape (cylindrical shape), for example, the diameter of the fixing belt is 30 mm and the width of the fixing belt is 370 mm. Further, as shown in FIG. 6 (a view showing the cross-sectional structure of the fixing belt 61), the fixing belt 61 is a belt member having a multilayer structure that includes a base layer 611, a conductive heating layer 612 stacked on the base layer 611, an elastic layer 613 improving the fixing property of a toner image, and a surface release layer 614 coated as a top layer.

The base layer 611 supports a thin conductive heating layer 612, and is formed of a heat-resistant sheet-like member that has the mechanical strength of the entire fixing belt 61. Further, the base layer 611 is made of a material having properties (relative magnetic permeability and specific resistance) and a thickness, which allow the passage of a magnetic field, so that the AC magnetic field generated by the IH heater 80 acts on the temperature-sensitive magnetic member 64. Meanwhile, the base layer 611 itself is formed so that the base layer does not generate heat or hardly generates heat by the action of a magnetic field. Specifically, for example, a non-magnetic metal such as non-magnetic stainless steel having a thickness in the range of 30 to 200 μm (preferably 50 to 150 μm), a resin material having a thickness in the range of 60 to 200 μm, or the like may be used as the base layer 611.

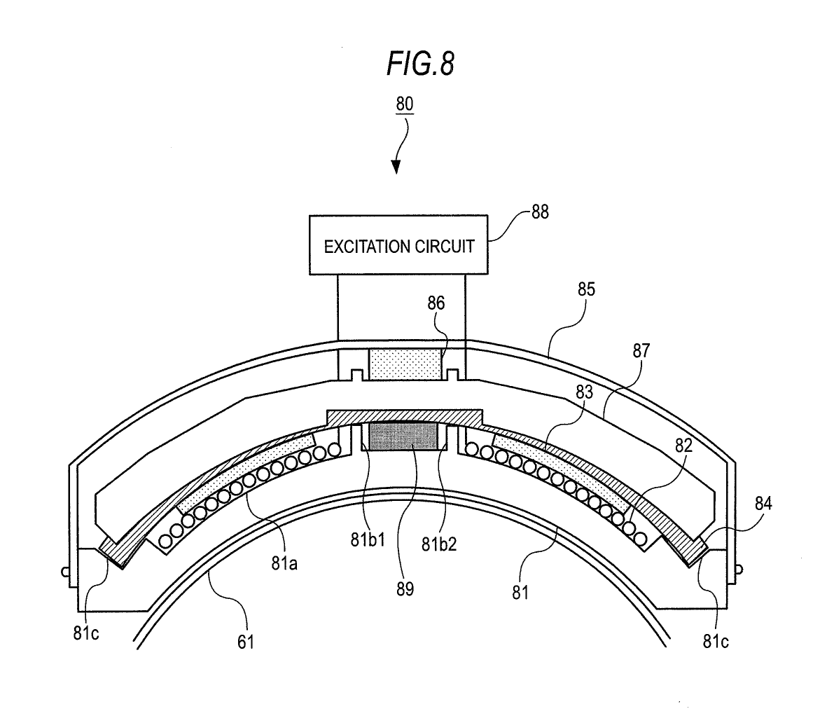

The conductive heating layer 612 is an electromagnetic induction heating element layer that is heated by electromagnetic induction with the AC magnetic field generated by the IH heater 80. That is, the conductive heating layer 612 is a layer that generates eddy current when an AC magnetic field generated by the IH heater 80 passes through the conductive heating layer 612 in a thickness direction. In general, a general-purpose power source, which can be manufactured at low cost, is used as a power source of an excitation circuit (see FIG. 8 to be described below) that supplies alternating current to the IH heater 80. For this reason, the frequency of the AC magnetic field, which is generated by the IH heater 80, is generally in the range of 20 to 100 kHz that corresponds to the frequency of an AC magnetic field generated by a general-purpose power source.

Accordingly, the conductive heating layer 612 is formed so that an AC magnetic field having a frequency in the range of 20 to 100 kHz penetrates and passes through the conductive heating layer.

An area of the conductive heating layer 612 where an AC magnetic field can penetrate is defined as “surface depth (δ)” that is an area where the AC magnetic field is reduced to 1/e, and is derived from the following Expression (1). In Expression (1), f denotes the frequency (for example, 20 kHz) of an AC magnetic field and p denotes a specific resistance value (Ω·m), and μᵣ denotes relative magnetic permeability. Accordingly, the thickness of the conductive heating layer 612 is smaller than the surface depth (δ) of the conductive heating layer 612 that is defined by Expression (1) so that an AC magnetic field having a frequency in the range of 20 to 100 kHz penetrates and passes through the conductive heating layer 612. Further, for example, metals, such as Au, Ag, Al, Cu, Zn, Sn, Pb, Bi, Be, and Sb, or metal alloys thereof are used as the material of the conductive heating layer 612.

$$\begin{matrix}[ Expression 1 ] & \\ δ = 503 \sqrt{\frac{ρ}{f \cdot {μ}_{r}}} & ( 1 )\end{matrix}$$

Specifically, a non-magnetic metal (of which a relative magnetic permeability is roughly 1), such as Cu, which has a thickness in the range of 2 to 20 μm and a specific resistance of 2.7×10⁻⁸Ω·m or less, is used as the conductive heating layer 612. Moreover, even in terms of the reduction of the time (hereinafter, referred to as “warm-up time”) that is required to heat the fixing belt 61 to a set fixing temperature, it is preferable that the conductive heating layer 612 be formed of a thin layer.

Next, the elastic layer 613 is formed of a heat-resistant elastic body such as silicone rubber. A toner image held on a sheet P, which is an object to which an image is fixed, is formed by stacking the respective color toners that are powder. For this reason, in order to uniformly supply heat to the entire toner image at a nip portion N, it is preferable that the surface of the fixing belt 61 be deformed according to the unevenness of the toner image held on the sheet P. Accordingly, for example, silicone rubber, which has a thickness in the range of 100 to 600 ml and a hardness in the range of 10 to 30° (JIS-A), is suitable for the elastic layer 613.

Since the surface release layer 614 comes into direct contact with unfixed toner images that are held on the sheet P, a material having a high releasing property is used for the surface release layer. For example, PFA (tetrafluoroethylene-perfluoroalkylvinyl ether polymer), PTFE (polytetrafluoroethylene), a silicone copolymer, a composite layer thereof, and the like may be used as the surface release layer. If the surface release layer 614 is excessively thin, the abrasion resistance of the surface release layer 614 is not sufficient, such that the life of the fixing belt 61 is shortened. Meanwhile, if the surface release layer 614 is excessively thick, the heat capacity of the fixing belt 61 is excessively large, such that warm-up time is increased. Accordingly, in consideration of the balance between abrasion resistance and heat capacity, it is preferable that the thickness of the surface release layer 614 be in the range of 1 to 50 μm.

<Description of Pressing Pad>

The pressing pad 63 is formed of an elastic body, such as silicone rubber or fluoro rubber, and is supported at a position, which faces the pressure roller 62, by the holder 65. Further, the pressing pad is disposed so as to be pressed by the pressure roller 62 with the fixing belt 61 interposed therebetween, and forms a nip portion N (an example of a pressing portion), where a sheet P is pressed, together with the pressure roller 62. Here, the pressure roller 62 may be perceived as a forming member that forms a pressing portion, where a sheet P is pressed, between itself and the fixing belt 61.

Moreover, different nip pressures are set at a pre-nip area 63a of the pressing pad 63 that is formed on the inlet side of the nip portion N (on the upstream side in a conveying direction of a sheet P) and at a separation nip area 63b of the pressing pad 63 that is formed on the outlet side of the nip portion N (on the downstream side in the conveying direction of a sheet P). That is, the surface of the pre-nip area 63a facing the pressure roller 62 is formed in a circular arc shape substantially following the outer peripheral surface of the pressure roller 62, and forms a nip portion N of which the width is uniform and large. Further, the separation nip area 63b is locally pressed with large nip pressure by the surface of the pressure roller 62 so that the radius of curvature of the fixing belt 61, which passes through the separation nip area 63b, is reduced. Accordingly, curl in a direction where a sheet is separated from the surface of the fixing belt 61 (down curl) is formed at a sheet P that passes through the separation nip area 63b, so that the separation of the sheet P from the surface of the fixing belt 61 is facilitated.

Meanwhile, in this exemplary embodiment, the auxiliary separating member 173 is disposed on the downstream side of the nip portion N as an auxiliary unit that assists in separating the sheet by the pressing pad 63. A separation baffle 171 is provided at the auxiliary separating member 173 in a direction, which is opposite to the rotational moving direction of the fixing belt 61, (a so-called counter direction) so as to come close to the fixing belt 61. Meanwhile, the separation baffle 171 is supported by a holder 172. Here, in this exemplary embodiment, a curled portion, which is formed at the sheet P at the outlet of the pressing pad 63, is supported by the separation baffle 171. Accordingly, the sheet P is prevented from being directed to the fixing belt 61.

<Description of Temperature-Sensitive Magnetic Member>

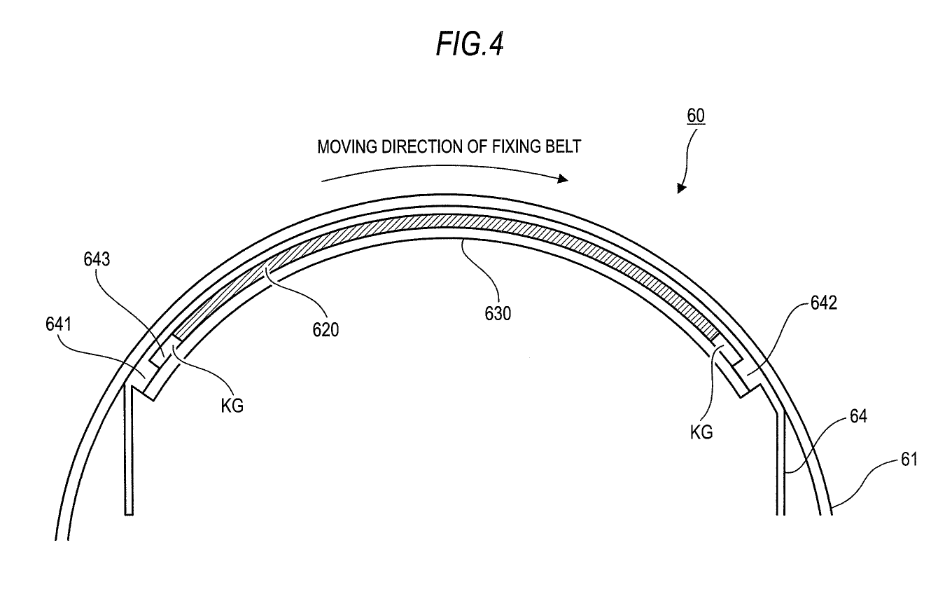

The temperature-sensitive magnetic member 64 serving as an example of a contact member is disposed so as to come into contact with the inner peripheral surface of the fixing belt as shown in FIG. 4 (a view illustrating the temperature-sensitive magnetic member 64). Further, a portion of the temperature-sensitive magnetic member 64, which comes into contact with the inner peripheral surface of the fixing belt 61, is formed in a circular arc shape following the inner peripheral surface of the fixing belt 61. Furthermore, a “magnetic permeability change start temperature” (to be described below) where the magnetic property, that is, magnetic permeability of the temperature-sensitive magnetic member 64, is suddenly changed is not lower than the set fixing temperature where each color toner image is melted, and the temperature-sensitive magnetic member is made of a material of which a heat resistance temperature is set in the temperature range lower than the heat resistance temperature of the elastic layer 613 or the surface release layer 614 of the fixing belt 61. That is, the temperature-sensitive magnetic member 64 is made of a material having a property (a temperature-sensitive magnetic property) that is reversibly changed between ferromagnetism and non-magnetism (paramagnetism) in a temperature range including the set fixing temperature.

Moreover, the temperature-sensitive magnetic member 64 forms magnetic paths, which pass through the temperature-sensitive magnetic member 64, by inducing magnetic field lines, which are generated by the IH heater 80 and penetrate the fixing belt 61, therein in a temperature range not higher than the magnetic permeability change start temperature where the temperature-sensitive magnetic member has a ferromagnetic property. Accordingly, the temperature-sensitive magnetic member 64 forms closed magnetic paths in which the fixing belt 61 and an exciting coil 82 (see FIG. 8 to be described below) of the IH heater 80 are included. Meanwhile, in a temperature range exceeding the magnetic permeability change start temperature, the temperature-sensitive magnetic member 64 transmits the magnetic field lines, which are generated by the IH heater 80 and penetrate the fixing belt 61, so as to make the magnetic field lines cross the temperature-sensitive magnetic member 64 in the thickness direction of the temperature-sensitive magnetic member. Accordingly, the magnetic field lines, which are generated by the IH heater 80 and penetrate the fixing belt 61, form magnetic paths that penetrate the temperature-sensitive magnetic member 64, pass through the induction member 66, and return to the IH heater 80.

Meanwhile, the “magnetic permeability change start temperature”, which has been described here, is a temperature where magnetic permeability (for example, magnetic permeability measured by JIS C2531) starts to be continuously reduced, and means a temperature where the amount of magnetic flux (the number of magnetic field lines) penetrating a member such as the temperature-sensitive magnetic member 64 starts to change. Accordingly, the magnetic permeability change start temperature becomes a temperature close to a Curie point that is a temperature where magnetism is lost, but is different from the Curie point in concept.

A binary temperature-sensitive magnetic alloy such as an Fe—Ni alloy (Permalloy), a ternary temperature-sensitive magnetic alloy such as an Fe—Ni—Cr alloy, or the like of which the magnetic permeability change start temperature is set in the range of, for example, 140° C. (a set fixing temperature) to 240° C. may be used as a material used for the temperature-sensitive magnetic member 64. For example, in the case of an Fe—Ni binary temperature-sensitive magnetic alloy, it may be possible to set a magnetic permeability change start temperature to about 225° C. by setting a ratio (atomic number ratio) of Fe to about 64% and setting a ratio (atomic number ratio) of Ni to about 36%. Since a metal alloy, such as Permalloy or the temperature-sensitive magnetic alloy, is excellent in moldability or workability, has high thermal conductivity, and is inexpensive, the metal alloy, such as Permalloy or the temperature-sensitive magnetic alloy is suitable for the temperature-sensitive magnetic member 64. Metal alloys, which include Fe, Ni, Si, B, Nb, Cu, Zr, Co, Cr, V, Mn, Mo, or the like, are used as other materials. Further, the temperature-sensitive magnetic member 64 is formed to have a thickness larger than the surface depth δ (see Expression (1)) that corresponds to the AC magnetic field (magnetic field lines) generated by the IH heater 80. Specifically, when, for example, an Fe—Ni alloy is used, the thickness of the temperature-sensitive magnetic member 64 is set to about 50 to 300 μm. Meanwhile, the structure and function of the temperature-sensitive magnetic member 64 will be described in more detail below.

Further, in this exemplary embodiment, as shown in FIG. 4, a heating element 620, which is disposed so as to come into contact with the back surface of the temperature-sensitive magnetic member 64 and heats the temperature-sensitive magnetic member 64, is provided on the back surface side of the temperature-sensitive magnetic member 64 (on the surface side opposite to the surface of the temperature-sensitive magnetic member coming into contact with the fixing belt 61). In other words, there is provided a heating element 620 as an example of a heating member that is positioned on the side distant from the fixing belt 61 as compared to the temperature-sensitive magnetic member 64 and heats the temperature-sensitive magnetic member 64. Furthermore, in this exemplary embodiment, first and second protruding portions 641 and 642, which protrude from the back surface of the temperature-sensitive magnetic member 64, are formed on the back surface of the temperature-sensitive magnetic member 64. Here, the first protruding portion 641 is disposed on the upstream side in the moving direction of the fixing belt 61, and is formed along the width direction of the fixing belt 61 (in a direction orthogonal to the moving direction of the fixing belt 61). Moreover, the second protruding portion 642 is disposed on the downstream side in the moving direction of the fixing belt 61, and is formed along the width direction of the fixing belt 61. Further, in this exemplary embodiment, a recessed portion 643 is formed between the first and second protruding portions 641 and 642 and the heating element 620 is received in the recessed portion 643.

Furthermore, in this exemplary embodiment, a metal plate 630 is provided on the back surface side of the temperature-sensitive magnetic member 64 and on the inner side of the fixing belt 61 as compared to the heating element 620. In other words, in this exemplary embodiment, a metal plate 630 is provided on the side distant from the fixing belt 61 as compared to the heating element 620. Here, the metal plate 630 is disposed so as to come into contact with the heating element 620. Moreover, the metal plate 630 is curved so as to swell out toward the inner peripheral surface of the fixing belt 61. In addition, the metal plate 630 is disposed along the width direction of the fixing belt 61. Further, in this exemplary embodiment, one end portion (an end portion that is positioned on the upstream side in the moving direction of the fixing belt 61) of the metal plate 630 comes into contact with the first protruding portion 641 of the temperature-sensitive magnetic member 64 and the other end portion (an end portion that is positioned on the downstream side in the moving direction of the fixing belt 61) of the metal plate 630 comes into contact with the second protruding portion 642 of the temperature-sensitive magnetic member 64. Meanwhile, the metal plate 630 may be made of, for example, Al (aluminum).

Although not shown, an insulating layer made of polyimide or the like is provided between the heating element 620 and the temperature-sensitive magnetic member 64, and is provided between the heating element 620 and the metal plate 630. Further, in order to increase the amount of heat that is transferred to the temperature-sensitive magnetic member 64 from the heating element 620, grease or oil (not shown) is provided between the heating element 620 and the temperature-sensitive magnetic member 64. Meanwhile, in order to reduce frictional resistance between the fixing belt 61 and the pressing pad 63, oil or grease is applied to the inner surface of the fixing belt 61. The same grease or oil as the grease or oil, which is applied to the inner surface of the fixing belt 61, may be used as the grease or oil that is provided between the heating element and the temperature-sensitive magnetic member.

Moreover, the heating element 620 is not fixed to the temperature-sensitive magnetic member 64 and is not fixed to the metal plate 630. In other words, the heating element 620 is just received in a gap formed between the temperature-sensitive magnetic member 64 and the metal plate 630, so that the heating element 620 is positioned. Here, the heating element 620 may be fixed to the temperature-sensitive magnetic member 64 and the metal plate 630. However, when the heating element 620 generates heat in this case, the heating element 620 and the temperature-sensitive magnetic member 64 interfere with each other or the heating element 620 and the metal plate 630 interfere with each other due to the difference in the coefficient of thermal expansion. For this reason, there is a concern that damage or the like of the heating element 620 is caused. Accordingly, this exemplary embodiment employs a structure where the heating element 620 is not fixed to the temperature-sensitive magnetic member 64 and the metal plate 630 as described above. In other words, there is employed a structure where the heating element 620 can move relative to the temperature-sensitive magnetic member 64 and the metal plate 630.

Further, in this exemplary embodiment, as shown in FIG. 4, the length of the heating element 620 in the rotational direction of the fixing belt 61 is set to be smaller than a distance between the first and second protruding portions 641 and 642 (a distance in the rotational direction of the fixing belt 61). For this reason, in this exemplary embodiment, a gap KG is formed between the heating element 620 and the first protruding portion 641 and is formed between the heating element 620 and the second protruding portion 642. As a result, the interference between the first protruding portion 641 and the heating element 620 that is elongated by generated heat, and the interference between the second protruding portion 642 and the heating element 620 that is elongated by generated heat are avoided in the fixing unit 60 according to this exemplary embodiment.

When fixing is performed by the fixing unit 60 in this exemplary embodiment, the fixing belt 61 is heated by the IH heater 80. Here, when fixing is performed by the fixing unit 60 in this exemplary embodiment, current is supplied to the heating element 620, so that the heating element 620 also generates heat. Further, heat generated by the heating element 620 is supplied to the fixing belt 61 through the temperature-sensitive magnetic member 64. Accordingly, in this exemplary embodiment, the time (warm-up time) that is required to heat the fixing belt 61 to a set fixing temperature is shortened as compared to the case where the fixing belt 61 is heated only by the IH heater 80. It may be possible to heat the fixing belt 61 by the heating element 620 not only at the time of warm-up but also at the time of a general fixing operation.

Meanwhile, a part of the heat generated by the heating element 620 is transferred to the fixing belt 61, but the other part of the heat is radiated to the inside of the fixing belt 61. For this reason, the metal plate 630 serving as an example of a receiving member is provided in this exemplary embodiment and the metal plate 630 receives the heat radiated to the inside of the fixing belt 61, so that the recovery of heat is facilitated. Here, the heat, which is recovered by the metal plate 630, is supplied to a main body portion of the temperature-sensitive magnetic member 64 through the first and second protruding portions 641 and 642 functioning as transfer portions temporarily, and is then supplied to the fixing belt 61.

In this case, when heat is to be transferred to plural portions, of which the positions are different from each other, of the temperature-sensitive magnetic member 64 by using plural portions (places) such as the first and second protruding portions 641 and 642, recovered heat is more efficiently transferred to the temperature-sensitive magnetic member 64. In other words, as compared to the case where heat is transferred to one place of the temperature-sensitive magnetic member 64, a possibility that heat is transferred to a portion, of which the temperature is low, of the temperature-sensitive magnetic member 64 is increased and the efficiency of heat transfer to the temperature-sensitive magnetic member 64 from the metal plate 630 is improved.

Further, since one surface of the heating element 620 (the surface of the heating element facing the fixing belt 61) loses heat to the fixing belt 61, an excessive temperature rise does not easily occur on one surface of the heating element. However, an excessive temperature rise is apt to occur on the other surface of the heating element (the surface of the heating element opposite to the surface of the heating element facing the fixing belt 61). In this case, there is a concern that the damage or the like of the heating element 620 is caused. For this reason, the metal plate 630 comes into contact with the other surface of the heating element in this exemplary embodiment. In this case, since the other surface of the heating element 620 loses heat to the metal plate 630, the excessive temperature rise of the heating element 620 is suppressed, such that the damage to the heating element 620 is suppressed.

Further, when small-sized sheets P are successively conveyed, temperature variation occurs on the fixing belt 61 between a passing area where the sheets P pass and a non-passing area where the sheets P do not pass. If a large-size sheet P is conveyed while the temperature variation occurs, fixing variation or the like is apt to occur. Since the metal plate 630 is provided along the width direction of the fixing belt 61 in this exemplary embodiment, heat is transferred to a low-temperature portion of the fixing belt 61 from a high-temperature portion of the fixing belt 61 through the metal plate 630. As a result, the temperature variation is removed, so that fixing variation does not easily occur.

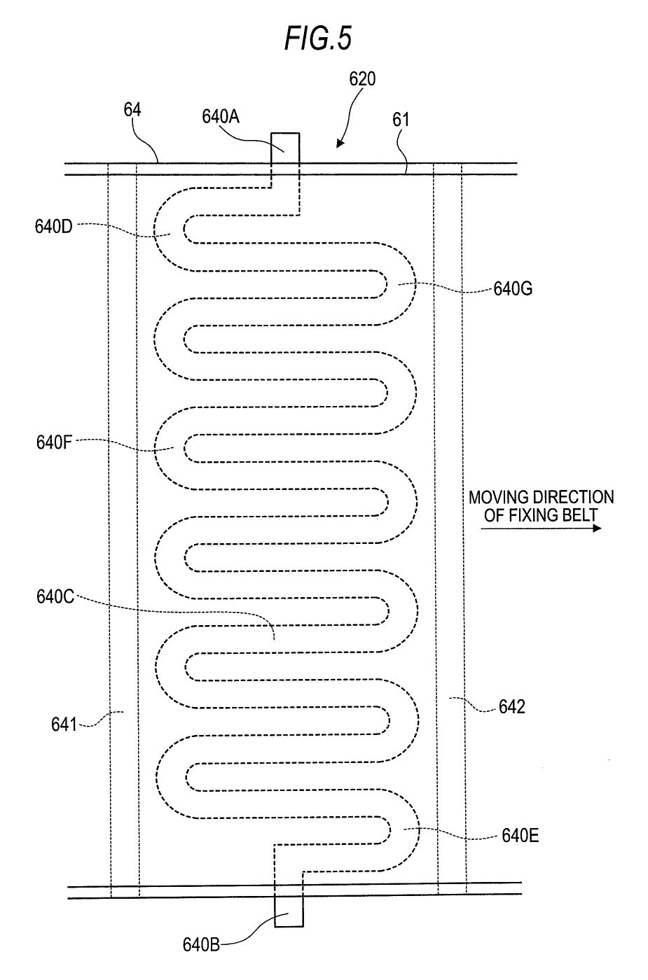

FIG. 5 is a view illustrating the heating element 620. In other words, FIG. 5 is a view of the heating element 620 when seen from the outside of the fixing belt 61. Meanwhile, the fixing belt 61 and the temperature-sensitive magnetic member 64 are also shown in FIG. 5.

The heating element 620 of this exemplary embodiment is made of stainless steel having a thickness of about 30 μm, and generates heat when current is supplied to the heating element. More specifically, the heating element 620 is disposed along the width direction of the fixing belt 61. Further, the heating element 620 is formed in a meandering shape where the heating element meanders between one end portion of the heating element in a longitudinal direction and the other end portion thereof. More specifically, the heating element 620 includes a first linear portion 640A that is formed in a linear shape at one end of the heating element in the longitudinal direction, and a second linear portion 640B that is formed in a linear shape at the other end of the heating element in the longitudinal direction. In addition, the heating element 620 includes plural third linear portions 6400 that are disposed along the moving direction of the fixing belt 61. Further, in this exemplary embodiment, the heating element includes a first connection portion 640D that connects the first linear portion 640A to the third linear portion 640C positioned at a place closest to the first linear portion 640A, and a second connection portion 640E that connects the second linear portion 640E to the third linear portion 640C positioned at a place closest to the second linear portion 640B. Furthermore, the heating element includes third connection portions 640F and fourth connection portions 640G. The third connection portions 640F connect end portions of the third linear portions 640C that are positioned on the upstream side in the moving direction of the fixing belt 61. The fourth connection portions 640G connect end portions of the third linear portions 640C that are positioned on the downstream side in the moving direction of the fixing belt 61. Meanwhile, each of the first to fourth connection portions 640D to 640G is formed in a circular arc shape.

Although not described above, the metal plate 630 may be fixed to the temperature-sensitive magnetic member 64 by fasteners such as screws. Further, the recessed portion 643, which receives the heating element 620, has been formed at the temperature-sensitive magnetic member 64 in the above-mentioned exemplary embodiment. However, the recessed portion 643 may be formed at the metal plate 630. Furthermore, in the above-mentioned exemplary embodiment, the heat of the metal plate 630 has been transferred to the temperature-sensitive magnetic member 64 by the first and second protruding portions 641 and 642, which are formed integrally with the main body portion of the temperature-sensitive magnetic member 64. However, the invention is not limited to the above-mentioned exemplary embodiment, and it may be possible to transfer the heat of the metal plate 630 to the temperature-sensitive magnetic member 64 by providing a member, which is formed separately from the temperature-sensitive magnetic member 64 and the metal plate 630, between the temperature-sensitive magnetic member 64 and the metal plate 630.

Moreover, the first and second protruding portions 641 642 have been formed integrally with the temperature-sensitive magnetic member 64 in the above-mentioned exemplary embodiment. However, the first and second protruding portions 641 and 642 may be formed integrally with the metal plate 630. Further, the fixing device 60 according to this exemplary embodiment has been formed so that the fixing belt 61 is heated by the IH heater 80. However, the invention is not limited to the above-mentioned exemplary embodiment, and a roller-like member in which a heater is built may come into contact with the fixing belt 61 so as to heat the fixing belt 61. Furthermore, the heating element 620 has played an auxiliary role in this exemplary embodiment, but the IH heater 80 may be omitted and the heating element 620 may be used as a main heating source. Moreover, the structure where the heating element 620 is provided inside the fixing belt 61 and heats the fixing belt 61 from the inside has been exemplified above. However, the invention is not limited to this structure, and the heating element 620 may be provided outside the fixing belt 61 and heat the fixing belt 61 from the outside.

<Description of Holder>

Returning to FIG. 3, the holder 65 will be described. The holder 65, which supports the pressing pad 63, is made of a material having high rigidity such that the amount of deflection of the pressing pad is not larger than a predetermined amount when the pressing pad 63 receives a pressing force from the pressure roller 62. Accordingly, the uniformity of pressure (nip pressure) is maintained in the longitudinal direction of the nip portion N. In addition, since the structure where the fixing belt 61 is heated by electromagnetic induction has been used in the fixing unit 60 according to this exemplary embodiment, the holder 65 is made of a material that does not affect an induced magnetic field or hardly affects an induced magnetic field and a material that is not affected by an induced magnetic field or is hardly affected by an induced magnetic field. For example, a heat-resistant resin such as glass-containing PPS (Polyphenylene Sulfide), non-magnetic metal materials, such as Al, Cu, and Ag, and the like may be used as a material of the holder. Meanwhile, the holder 65 also supports the temperature-sensitive magnetic member 64 and the induction member 66. One end of the temperature-sensitive magnetic member 64 and one end of the induction member 66 do not have been supported in FIG. 3. However, one end of the temperature-sensitive magnetic member 64 and one end of the induction member 66 are supported by the holder 65 through members (not shown).

<Description of Induction Member<

The induction member 66 is formed in a circular arc shape following the inner peripheral surface of the temperature-sensitive magnetic member 64, and is disposed so as not to come into contact with the inner peripheral surface of the temperature-sensitive magnetic member 64 with a predetermined gap (for example, 1.0 to 5.0 mm) therebetween. Further, the induction member 66 is made of a non-magnetic metal having a relatively small specific resistance value, such as Ag, Cu, or Al. Furthermore, when the temperature of the temperature-sensitive magnetic member 64 rises to a temperature not lower than a magnetic permeability change start temperature, the temperature-sensitive magnetic member 64 forms a state where eddy current I is more easily generated as compared to the conductive heating layer 612 of the fixing belt 61 by inducing the AC magnetic field (magnetic field lines) generated by the IH heater 80. Accordingly, the induction member 66 is formed to have a predetermined thickness (for example, 1.0 mm) sufficiently larger than the surface depth δ (see Expression (1)) so that eddy current I easily flows.

<Description of Drive Mechanism for Fixing Belt>

Next, a drive mechanism for the fixing belt 61 will be described.

As shown in FIG. 2 that is a front view, end cap members 67, which rotationally drive the fixing belt 61 in a circumferential direction while maintaining the circular cross-sectional shape of the both end portions of the fixing belt 61, are fixed to both end portions of the holder 65 (see FIG. 3) in the axial direction of the holder. Further, the fixing belt 61 directly receives a rotational driving force transmitted through the end cap members 67 from both end portions of the fixing belt, so that the fixing belt is rotationally moved in the direction of an arrow C of FIG. 3 at a process speed of, for example, 140 mm/s.

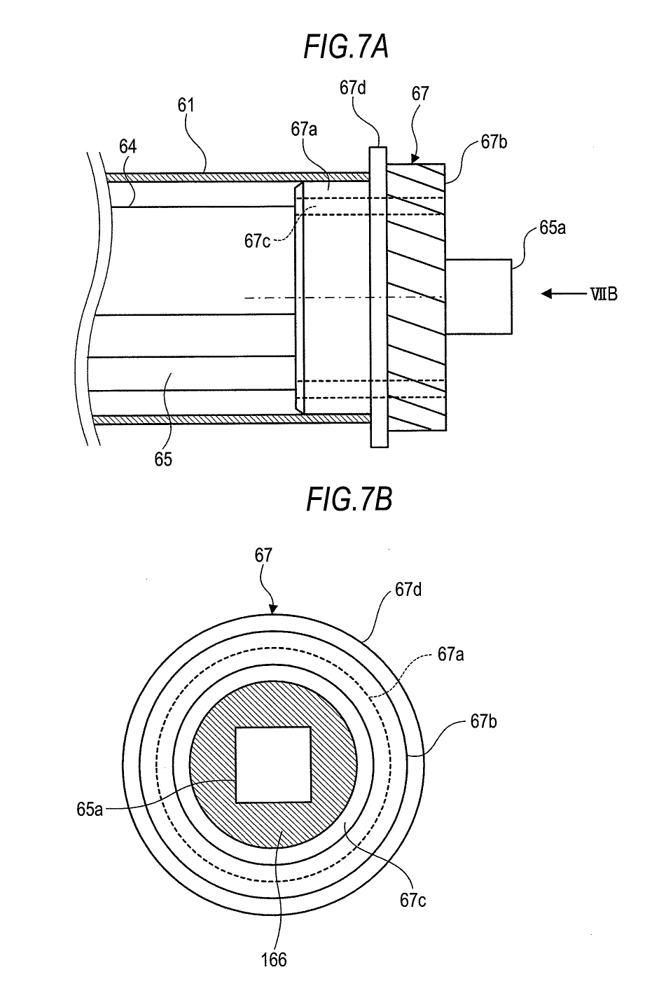

FIG. 7A is a side view of the end cap member 67, and FIG. 7B is a plan view of the end cap member 67 seen from the direction of an arrow VIIB. As shown in FIG. 7, the end cap member 67 includes a fixing portion 67a that is fitted into each of both end portions of the fixing belt 61, a flange portion 67d that is formed to have an outer diameter larger than the outer diameter of the fixing portion 67a and is formed to protrude from the fixing belt 61 in a radial direction when being mounted on the fixing belt 61, a gear portion 67b to which a rotational driving force is transmitted, and a bearing portion 67c that is rotatably joined to a support portion 65a formed at each of both end portions of the holder 65 through a joining member 166. Further, the support portions 65a, which are formed at both end portions of the holder 65, are fixed to both end portions of a housing 69 of the fixing unit 60 as shown in FIG. 2, so that the end cap members 67 are rotatably supported through the bearing portions 67c joined to the support portions 65a.

So-called engineering plastics, which have high mechanical strength or heat resistance, are used as a material of the end cap member 67. For example, a phenolic resin, a polyimide resin, a polyamide resin, a polyamide-imide resin, a PEEK resin, a PES resin, a PPS resin, an LCP resin, and the like are suitable as a material of the end cap member.

Further, as shown in FIG. 2, in the fixing unit 60, a rotational driving force generated from a drive motor 90 is transmitted to a shaft 93 through transmission gears 91 and 92 and is transmitted to the gear portions 67b (see FIG. 7) of both the end cap members 67 from transmission gears 94 and 95 joined to the shaft 93. Accordingly, a rotational driving force is transmitted to the fixing belt 61 from the end cap members 67, so that the end cap members 67 and the fixing belt 61 are rotationally driven as a single body. Since the fixing belt 61 directly receives a driving force from both end portions of the fixing belt 61 and is rotated as described above, the fixing belt 61 is stably rotated.

Here, when the fixing belt 61 directly receives a driving force from the end cap members 67 fixed to both end portions of the holder and is rotated, torque in the range of about 0.1 to 0.5 N·m generally acts on the fixing belt. Meanwhile, the base layer 611 of the fixing belt 61 of this exemplary embodiment is made of, for example, non-magnetic stainless steel, which has high mechanical strength, or the like. For this reason, even when torsional torque in the range of about 0.1 to 0.5 N·m acts on the entire fixing belt 61, buckling or the like hardly occurs on the fixing belt 61. Further, the deviation of the fixing belt 61 is suppressed by the flange portions 67d of the end cap members 67. However, in this case, a compressive force in the range of about 1 to 5 N is generally applied to the fixing belt 61 from the end portions (flange portions 67d) in the axial direction. Even though the fixing belt 61 receives the above-mentioned compressive force, the occurrence of buckling or the like is suppressed since the base layer 611 of the fixing belt 61 is made of non-magnetic stainless steel or the like.

Since the fixing belt 61 directly receives a driving force from both end portions of the fixing belt 61 and is rotated as described above, the fixing belt 61 is stably rotated. Further, the base layer 611 of the fixing belt 61 is made of, for example, non-magnetic stainless steel, which has high mechanical strength, or the like in this case, so that a structure where buckling or the like caused by torsional torque or a compressive force hardly occurs is realized. Furthermore, each of the base layer 611 and the conductive heating layer 612 is formed of a thin layer, so that flexibility of the entire fixing belt 61 is secured. Accordingly, the fixing belt is deformed and restored according to the shape of the nip portion N.

Returning to FIG. 3, the pressure roller 62 is disposed so as to face the fixing belt 61 and is rotated in the direction of an arrow D of FIG. 3 at a process speed of, for example, 140 mm/s by the fixing belt 61. Further, a nip portion N is formed while the fixing belt 61 is interposed between the pressure roller 62 and the pressing pad 63. Then, a sheet P on which unfixed toner images are held passes through the nip portion N, so that the unfixed toner images are fixed to the sheet P by heat and pressure.

The pressure roller 62 includes a solid aluminum core (columnar core metal) 621, a heat-resistant elastic body layer 622 of silicon sponge or the like, and a release layer 623 that are stacked. The core 621 has a diameter of, for example, 18 mm. The heat-resistant elastic body layer 622 has a thickness of, for example, 5 mm and is coated on the outer peripheral surface of the core 621. The release layer 623 is formed of a heat-resistant rubber coating or a heat-resistant resin coating such as a carbon-containing PFA having a thickness of, for example, 50 μm. Further, the pressure roller presses the pressing pad 63 at a load of, for example, 25 kgf by pressing springs 68 (see FIG. 2) with the fixing belt 61 interposed between the pressure roller and the pressing pad.

<Description of IH Heater>

Subsequently, there will be described the IH heater 80 that heats the conductive heating layer 612 by electromagnetic induction by making an AC magnetic field act on the conductive heating layer 612 of the fixing belt 61.

FIG. 8 is a cross-sectional view illustrating the structure of the IH heater 80 of this exemplary embodiment. As shown in FIG. 8, the IH heater 80 includes a support 81 and an exciting coil 82. The support 81 is formed of a non-magnetic body such as, for example, a heat-resistant resin. The exciting coil 82 generates an AC magnetic field. Further, the IH heater includes an elastic support member 83 and plural magnetic cores 84. The elastic support member 83 fixes the exciting coil 82 to the support 81, and is formed of an elastic body such as, for example, silicone rubber. The plural magnetic cores 84 are disposed along the width direction of the fixing belt 61, and form magnetic paths of the AC magnetic field that is generated by the exciting coil 82.

Furthermore, the IH heater includes plural adjustive magnetic cores 89, magnetic core holding members 87, a pressure member 86, a shield 85, and an excitation circuit 88. The plural adjustive magnetic cores 89 are disposed along the width direction of the fixing belt 61, and uniformize the AC magnetic field, which is generated by the exciting coil 82, in the longitudinal direction of the support 81. The magnetic core holding members 87 hold the magnetic cores 84 so as to cover the magnetic cores 84 from above. The pressure member 86 presses the magnetic cores 84 against the support 81 with the magnetic core holding members 87 interposed therebetween, and is formed of an elastic body such as, for example, silicone rubber. The shield 85 suppresses the leakage of a magnetic field to the outside by blocking a magnetic field. The excitation circuit 88 supplies alternating current to the exciting coil 82.

The support 81 is formed so that the cross-section of the support 81 is curved to follow the shape of surface of the fixing belt 61 and a predetermined gap (for example, 0.5 to 2 mm) is formed between the surface of the fixing belt 61 and an upper surface (hereinafter, referred to as a “supporting surface”) 81a of the support 81 supporting the exciting coil 82. Further, a pair of magnetic core supporting portions (convex portions) 81b1 and 81b2, which supports the magnetic cores 84, is disposed along the longitudinal direction of the support 81 (=a direction orthogonal to the moving direction of the fixing belt 61) in the middle of the supporting surface 81a so as to be parallel to each other. The magnetic core supporting portions 81b1 and 81b2 keep gaps between the magnetic cores 84 and the supporting surface 81a constant, and support the magnetic cores 84 so that the magnetic cores 84 can move in the rotational direction of the fixing belt 61.

Furthermore, magnetic core regulating portions 81c are disposed at both side portions of the supporting surface 81a. The magnetic core regulating portions 81c regulate the movement of the magnetic cores 84, which are supported by the magnetic core supporting portions 81b1 and 81b2, in the moving direction (arc direction) of the fixing belt 61 within a predetermined range, and set the positions of the magnetic cores 84 in the width direction of the fixing belt 61 (=the direction orthogonal to the moving direction).

For example, heat-resistant resins, such as heat-resistant glass, polycarbonate, polyether sulfone, and PPS (polyphenylene sulfide), or heat-resistant non-magnetic materials such as heat-resistant resins that are formed by mixing glass fiber to them are used as a material of the support 81.

The exciting coil 82 is formed by twisting litz wires in a hollow closed-loop shape, such as an oval or elliptical shape and a rectangular shape. Each of the litz wires is obtained by bundling, for example, 90 copper wire rods which are insulated from each other and each of which has a diameter of, for example, 0.17 mm. Further, when alternating current having a predetermined frequency is supplied to the exciting coil 82 from the excitation circuit 88, an AC magnetic field of which the center corresponds to the litz wires twisted in the closed-loop shape, is generated around the exciting coil 82. In general, the frequency of the alternating current, which is supplied to the exciting coil 82 from the excitation circuit 88, is in the range of 20 to 100 kHz that corresponds to the frequency of the AC magnetic field generated by the above-mentioned general-purpose power source.

The elastic support member 83 is a sheet-like member that is formed of an elastic body such as, for example, silicone rubber or fluoro rubber. The elastic support member 83 is set to press the exciting coil 82 against the support 81 so that the exciting coil 82 comes into close contact with and is fixed to the supporting surface 81a of the support 81.

A circular arc-shaped ferromagnet, which is made of, for example, fired ferrite, a ferrite resin, an amorphous alloy, or an alloy material or an oxide having high magnetic permeability, such as Permalloy or a temperature-sensitive magnetic alloy, is used as the magnetic core 84, and the magnetic core functions as a magnetic path forming member. The magnetic cores 84 induce magnetic field lines (magnetic flux), which are caused by the AC magnetic field generated by the exciting coil 82, therein; and form paths (magnetic paths) of magnetic field lines that cross the fixing belt 61 from the magnetic cores 84, head toward the temperature-sensitive magnetic member 64, pass through the temperature-sensitive magnetic member 64, and return to the magnetic cores 84. That is, the AC magnetic field, which is generated by the exciting coil 82, forms closed magnetic paths which are formed to pass through the inside of the magnetic cores 84 and the inside of the temperature-sensitive magnetic member 64 and in which magnetic field lines wrap the fixing belt 61 and the exciting coil 82 therein. Accordingly, the magnetic field lines of the AC magnetic field, which is generated by the exciting coil 82, are concentrated on an area that faces the magnetic cores 84 of the fixing belt 61.

Here, it is preferable that the magnetic cores 84 be made of a material having a small loss caused by the formation of magnetic paths. Specifically, it is preferable that the magnetic cores 84 be used in a form where the loss of eddy current is small (the segmentation and isolation or blocking of a current path by slits or the like, a bundle of thin plates, and the like) and be made of a material having a small hysteresis loss.

Further, the length of the magnetic core 84 in the rotational direction of the fixing belt 61 is set to be smaller than that of the temperature-sensitive magnetic member 64 in the rotational direction of the fixing belt 61. Accordingly, the leakage of the magnetic field lines to the periphery of the IH heater 80 is reduced and a power factor is improved. Furthermore, the electromagnetic induction to the metal member of the fixing unit 60 is suppressed and the heating efficiency of the fixing belt 61 (conductive heating layer 612) is improved.

Each of the magnetic core holding members 87 is formed of a non-magnetic body, such as SUS or a resin, and holds each of the magnetic cores 84 so as to cover a part or all of the side surfaces except for the inner peripheral surface of the magnetic core 84 (the side surfaces in a direction orthogonal to the moving direction of the fixing belt 61) and a part or all of the outer peripheral surface (the side surface opposite to the side where the fixing belt 61 is disposed). Accordingly, the magnetic core holding member 87 restricts the movement of the magnetic core 84 within a predetermined area. For this reason, for example, even if any impact is applied to the magnetic core 84 and the magnetic core 84 is broken, the movement (scattering) of the fragments of the magnetic core 84 to other areas in the IH heater 80 is suppressed. Therefore, the magnetic core holding member 87 functions to suppress an abnormal temperature rise that occurs on the fixing belt 61 facing the fragments in a destination area due to the concentration of the AC magnetic field generated by the exciting coil 82, which is caused by the fragments of the magnetic core 84. Further, the magnetic core holding member 87 performs a function of transmitting a pressing force, which is applied from the pressure member 86, to the magnetic core 84 and a function of pressing the magnetic core 84 against the magnetic core supporting portions (convex portions) 81b1 and 81b2 formed at the support 81.

A rectangular parallelepiped (block-like) ferromagnet, which is made of, for example, fired ferrite, a ferrite resin, an amorphous alloy, or an alloy material or an oxide having high magnetic permeability, such as Permalloy or magnetic compensating steel, is used as the adjustive magnetic cores 89. Further, the adjustive magnetic cores 89 function as adjusted magnetic members. The adjusted magnetic members uniformize the intensity of the magnetic field, which corresponds to the longitudinal direction of the support 81, of the AC magnetic field that is generated by the temperature-sensitive magnetic member 64 and the magnetic cores 84 disposed around the exciting coil 82. The intensity of the magnetic field, which is generated in the longitudinal direction of the support 81, is averaged, so that the temperature variation (temperature deviation or temperature ripple) in the width direction of the fixing belt 61 is reduced. The adjustive magnetic cores 89 are disposed in a space that is formed in an area between the magnetic core supporting portions 81b1 and 81b2 (an area surrounded by inner walls of the magnetic core supporting portions 81b1 and 81b2).

<Description of State where Fixing Belt Generates Heat>

Subsequently, there will be described a state where the fixing belt 61 is heated by the AC magnetic field that is generated by the IH heater 80.

First, as described above, the magnetic permeability change start temperature of the temperature-sensitive magnetic member 64 is set in the temperature range (for example, 140 to 240° C.) that is not lower than the set fixing temperature where each color toner image is fixed and is not higher than the heat resistance temperature of the fixing belt 61. Further, when the temperature of the fixing belt 61 is not higher than the magnetic permeability change start temperature, the temperature of the temperature-sensitive magnetic member 64 disposed to come into contact with the fixing belt 61 also becomes not higher than the magnetic permeability change start temperature so as to correspond to the temperature of the fixing belt 61. For this reason, since the temperature-sensitive magnetic member 64 is ferromagnetic, the magnetic field lines H of the AC magnetic field generated by the IH heater 80 form magnetic paths that penetrate the fixing belt 61 and then pass through the inside of the temperature-sensitive magnetic member 64 along a spreading direction. Here, the “spreading direction” means a direction orthogonal to the thickness direction of the temperature-sensitive magnetic member 64.

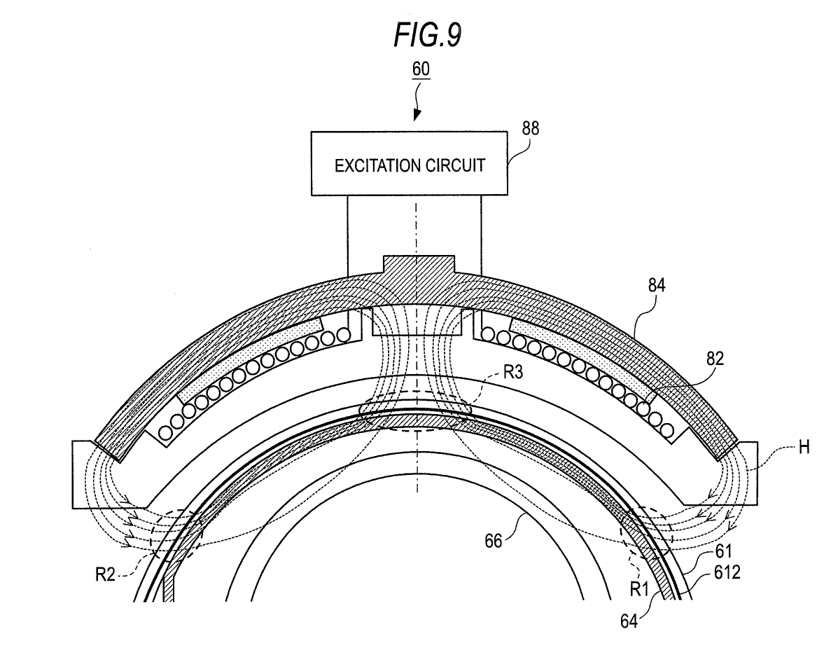

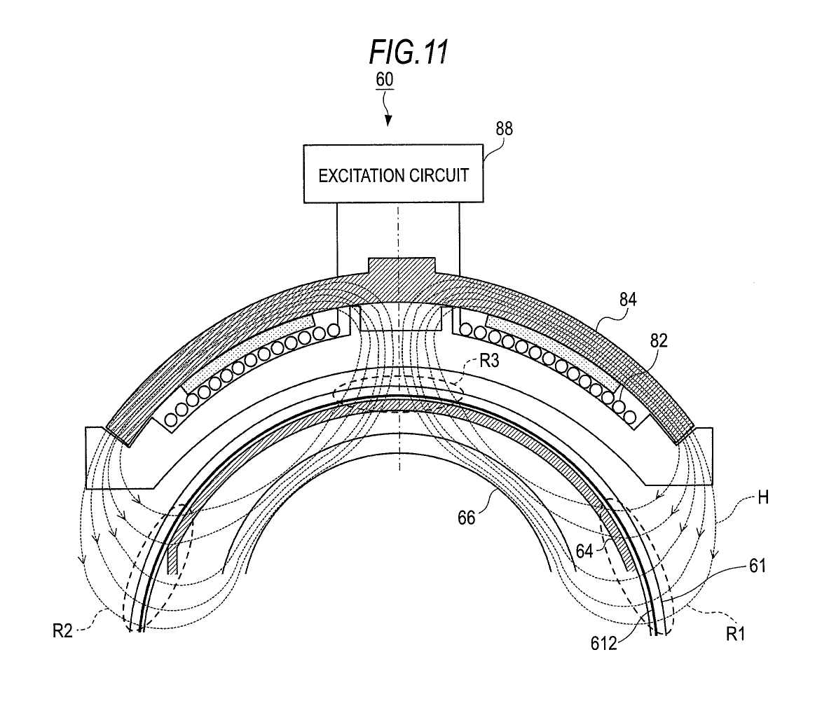

FIG. 9 is a view illustrating the state of magnetic field lines H when the temperature of the fixing belt 61 is in a temperature range not higher than the magnetic permeability change start temperature. Meanwhile, the heating element 620, the metal plate 630, the first protruding portion 641, and the second protruding portion 642, which have been described above, will not be shown in FIG. 9 or FIG. 11 to be described below.

When the temperature of the fixing belt 61 is in the temperature range not higher than the magnetic permeability change start temperature, the magnetic field lines H of the AC magnetic field generated by the IH heater 80 form magnetic paths that penetrate the fixing belt 61 and then pass through the inside of the temperature-sensitive magnetic member 64 along the spreading direction (the direction orthogonal to the thickness direction) as shown in FIG. 9. For this reason, the number of the magnetic field lines H (magnetic flux density) per unit area in an area, where the magnetic field lines H cross the conductive heating layer 612 of the fixing belt 61, is increased.

That is, after the magnetic field lines H are radiated from the magnetic cores 84 of the IH heater 80 and pass through areas R1 and R2 where the magnetic field lines H cross the conductive heating layer 612 of the fixing belt 61, the magnetic field lines H are induced into the temperature-sensitive magnetic member 64 that is a ferromagnet. For this reason, the magnetic field lines H, which cross the conductive heating layer 612 of the fixing belt 61 in the thickness direction, are concentrated so as to enter the inside of the temperature-sensitive magnetic member 64, so that magnetic flux density in the areas R1 and R2 is increased. Further, even when the magnetic field lines H, which have passed through the inside of the temperature-sensitive magnetic member 64 along the spreading direction, return to the magnetic cores 84 again, the magnetic field lines are concentrated from a portion of the temperature-sensitive magnetic member 64 where a magnetic potential is low and are radiated toward the magnetic cores 84 in an area R3 where the magnetic field lines H cross the conductive heating layer 612 in the thickness direction. For this reason, the magnetic field lines H, which cross the conductive heating layer 612 of the fixing belt 61 in the thickness direction, are concentrated from the temperature-sensitive magnetic member 64 and are directed to the magnetic cores 84, so that magnetic flux density in the area R3 is also increased.

Eddy current I, which is proportional to the variation of the number of the magnetic field lines H (magnetic flux density) per unit area, is generated in the conductive heating layer 612 of the fixing belt 61 that are crossed by the magnetic field lines H in the thickness direction. Accordingly, large eddy current I is generated in the areas R1, R2, and R3 where the variation of the magnetic flux density is large as shown in FIG. 9. The eddy current I, which is generated in the conductive heating layer 612, generates Joule heat W (W═I²R) that is the product of a specific resistance value R of the conductive heating layer 612 and the square of a value of the eddy current I. Accordingly, large Joule heat W is generated in the conductive heating layer 612 where large eddy current I is generated. When the temperature of the fixing belt 61 is in the temperature range not higher than the magnetic permeability change start temperature as described above, large amount of heat is generated in the areas R1 and R2, or the area R3 where the magnetic field lines H cross the conductive heating layer 612. Accordingly, the fixing belt 61 is heated.

Meanwhile, in the fixing unit 60 according to this exemplary embodiment, the temperature-sensitive magnetic member 64 is disposed on the inner peripheral surface side of the fixing belt 61 so as to come into contact with the fixing belt 61. Accordingly, the structure is realized where the magnetic cores 84 are close to the temperature-sensitive magnetic member 64. Here, the magnetic cores 84 induce the magnetic field lines H, which are generated by the exciting coil 82, therein, and the temperature-sensitive magnetic member 64 induces the magnetic field lines H, which cross and penetrate the fixing belt 61 in the thickness direction, therein. For this reason, since the AC magnetic field generated by the IH heater 80 (exciting coil 82) forms a loop having short magnetic paths, magnetic flux density or the degree of magnetic coupling in the magnetic paths is increased. Accordingly, when the temperature of the fixing belt 61 is in the temperature range not higher than the magnetic permeability change start temperature, heat is more efficiently generated in the fixing belt 61.

<Description of Function of Suppressing Temperature Rise of Non-Sheet-Passing Portion of Fixing Belt>

Next, a function of suppressing the temperature rise of a non-sheet-passing portion of the fixing belt 61 will be described.

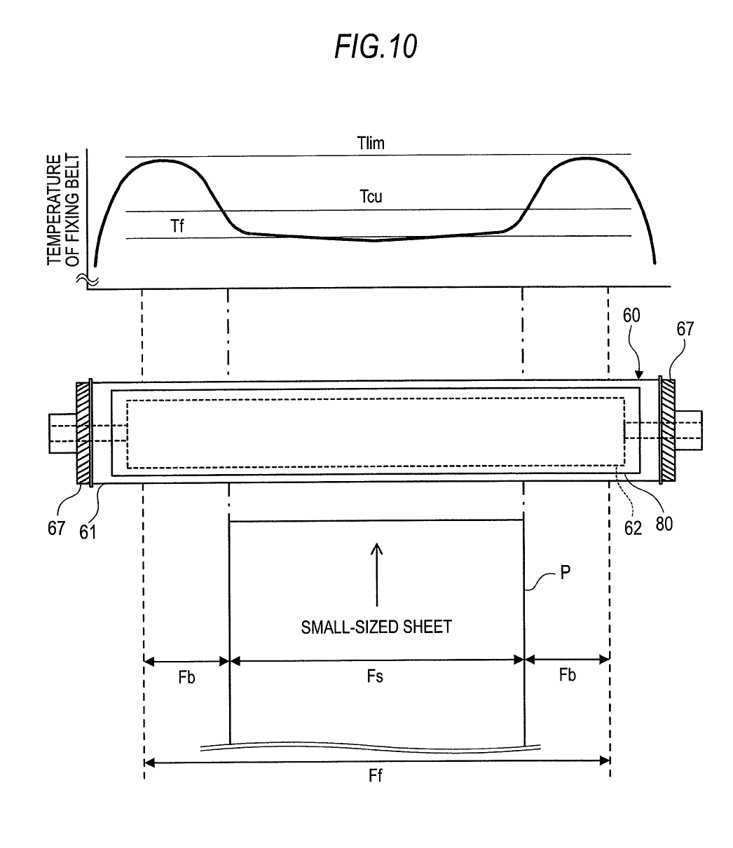

Here, a case where small-sized sheets P (small-sized sheet P1) successively pass through the fixing unit 60 will be described first. FIG. 10 is a view schematically showing temperature distribution of the fixing belt 61 in a width direction when small-sized sheets P1 successively pass. In FIG. 10, a maximum sheet passing area, which corresponds to the maximum width (for example, the width of an A3 sheet) of a sheet P used in the image forming apparatus 1, is denoted by Ff; an area (small-sized sheet-passing area) through which a small-sized sheet P1 (for example, the longitudinal feed of an A4 sheet) having a width smaller than the width of the largest sheet P passes is denoted by Fs; and a non-sheet-passing area through which a small-sized sheet P1 does not pass is denoted by Fb. Meanwhile, a sheet passes in the image forming apparatus 1 while a middle position is used as reference.

When small-sized sheets P1 successively pass as shown in FIG. 10, heat for fixing is consumed in the small-sized sheet-passing area Fs through which the small-sized sheets P1 pass. For this reason, temperature control at the set fixing temperature is performed by the control section 31 (see FIG. 1), so that the temperature of the fixing belt 61 in the small-sized sheet-passing area Fs is maintained in a range close to the set fixing temperature. Meanwhile, the same temperature control as the temperature control performed in the small-sized sheet-passing area Fs is also performed in the non-sheet-passing area Fb. However, heat for fixing is not consumed in the non-sheet-passing area Fb. For this reason, the temperature of the non-sheet-passing area Fb is apt to rise to a temperature higher than the set fixing temperature. Further, when small-sized sheets P1 continue to successively pass in this state, the temperature of the non-sheet-passing area Fb rises to a temperature higher than the heat resistance temperature of, for example, the elastic layer 613 or the surface release layer 614 of the fixing belt 61. As a result, the fixing belt 61 may be damaged.

As described above, in the fixing unit 60 according to this exemplary embodiment, the temperature-sensitive magnetic member 64 is made of, for example, an Fe—Ni alloy or the like of which a magnetic permeability change start temperature is set in the temperature range that is not lower than a set fixing temperature and is not higher than the heat resistance temperature of, for example, the elastic layer 613 or the surface release layer 614 of the fixing belt 61. That is, as shown in FIG. 10, a magnetic permeability change start temperature Tcu of the temperature-sensitive magnetic member 64 is set in the temperature range that is not lower than a set fixing temperature Tf and is not higher than a heat resistance temperature Tlim of, for example, the elastic layer 613 or the surface release layer 614.

Accordingly, when small-sized sheets P1 successively pass, the temperature of the fixing belt 61 in the non-sheet-passing area Fb exceeds the magnetic permeability change start temperature of the temperature-sensitive magnetic member 64. As a result, the temperature of the temperature-sensitive magnetic member 64, which is disposed so as to come into contact with the fixing belt 61, in the non-sheet-passing area Fb also exceeds the magnetic permeability change start temperature so as to correspond to the temperature of the fixing belt 61, like the temperature of the fixing belt 61. For this reason, the relative magnetic permeability of the temperature-sensitive magnetic member 64 in the non-sheet-passing area Fb approaches 1, and the properties of the temperature-sensitive magnetic member 64 as a ferromagnet are lost. If the relative magnetic permeability of the temperature-sensitive magnetic member 64 is reduced and approaches 1, the magnetic field lines H in the non-sheet-passing area Fb penetrate the temperature-sensitive magnetic member 64 without being induced into the temperature-sensitive magnetic member 64. For this reason, in the non-sheet-passing area Fb of the fixing belt 61, the magnetic field lines H having passed through the conductive heating layer 612 diffuse and the magnetic flux density of the magnetic field lines H crossing the conductive heating layer 612 is reduced. Accordingly, the eddy current I generated in the conductive heating layer 612 is reduced, so that the amount of heat (Joule heat W) generated in the fixing belt 61 is reduced. As a result, an excessive temperature rise in the non-sheet-passing area Fb is suppressed, so that the damage to the fixing belt 61 is suppressed. As described above, the temperature-sensitive magnetic member 64 has a function as a detection section that detects the temperature of the fixing belt 61, and a function as a temperature rise suppression section that suppresses the excessive temperature rise of the fixing belt 61 according to the detected temperature of the fixing belt 61.

The magnetic field lines H, which have passed through the temperature-sensitive magnetic member 64, reach the induction member 66 (see FIG. 3) and are induced into the induction member 66. When magnetic flux reaches the induction member 66 and is induced into the induction member 66, a lot of eddy current I flows in the induction member 66 where eddy current I more easily flows as compared to the conductive heating layer 612. For this reason, the amount of eddy current flowing in the conductive heating layer 612 is further suppressed, such that a temperature rise in the non-sheet-passing area Fb is suppressed.

In this case, the thickness, material, and shape of the induction member 66 are selected so that the induction member 66 suppresses the leakage of the magnetic field lines H from the fixing unit 60 by inducing most of the magnetic field lines H generated from the exciting coil 82. Specifically, the induction member 66 may be made of a material of which the surface depth δ is sufficiently large. Accordingly, even though eddy current I flows in the induction member 66, the amount of generated heat is also reduced as much as possible. In this exemplary embodiment, the induction member 66 is made of Al (aluminum) and is formed in a substantially circular shape following the temperature-sensitive magnetic member 64 so as to have a thickness of 1 mm, and is disposed so as not to come into contact with the temperature-sensitive magnetic member 64 (with an average distance of, for example, 4 mm therebetween). Ag and Cu may be used as other materials of the induction member 66.

After that, when the temperature of the fixing belt 61 in the non-sheet-passing area Fb becomes lower than the magnetic permeability change start temperature of the temperature-sensitive magnetic member 64, the temperature of the temperature-sensitive magnetic member 64 in the non-sheet-passing area Fb also becomes lower than the magnetic permeability change start temperature. Accordingly, the temperature-sensitive magnetic member 64 is changed into a ferromagnetic member again, such that the magnetic field lines H are induced into the temperature-sensitive magnetic member 64. Therefore, a lot of eddy current I flows in the conductive heating layer 612. For this reason, the fixing belt 61 is heated again.

FIG. 11 is a view illustrating the state of magnetic field lines H when the temperature of the fixing belt 61 in the non-sheet-passing area Fb is in a temperature range exceeding the magnetic permeability change start temperature. When the temperature of the fixing belt 61 in the non-sheet-passing area Fb is in the temperature range exceeding the magnetic permeability change start temperature, the relative magnetic permeability of the temperature-sensitive magnetic member 64 in the non-sheet-passing area Fb is reduced as shown in FIG. 11. For this reason, the magnetic field lines H of the AC magnetic field generated by the IH heater 80 are changed so as to easily penetrate the temperature-sensitive magnetic member 64. Accordingly, the magnetic field lines H of the AC magnetic field generated by the IH heater 80 (exciting coil 82) are radiated so as to diffuse toward the fixing belt 61 from the magnetic cores 84, and reach the induction member 66.

That is, since magnetic field lines H are hardly induced to the temperature-sensitive magnetic member 64 in the areas R1 and R2 where the magnetic field lines H are radiated from the magnetic cores 84 of the IH heater 80 and cross the conductive heating layer 612 of the fixing belt 61, the magnetic field lines H diffuse radially. Accordingly, the magnetic flux density of the magnetic field lines H (the number of the magnetic field lines H per unit area), which cross the conductive heating layer 612 of the fixing belt 61 in the thickness direction, is reduced. Further, when the magnetic field lines H return to the magnetic cores 84 again, the magnetic field lines H return to the magnetic cores 84 from the wide area, where the magnetic field lines diffuse, even in the area R3 where the magnetic field lines H cross the conductive heating layer 612 in the thickness direction. Accordingly, the magnetic flux density of the magnetic field lines H, which cross the conductive heating layer 612 of the fixing belt 61 in the thickness direction, is reduced.

For this reason, when the temperature of the fixing belt 61 is in the temperature range exceeding the magnetic permeability change start temperature, the magnetic flux density of the magnetic field lines H crossing the conductive heating layer 612 in the thickness direction in the areas R1 and R2 or the area R3 is reduced. Accordingly, eddy current I, which is generated in the conductive heating layer 612 crossed in the thickness direction by the magnetic field lines H, is reduced and Joule heat W generated in the fixing belt 61 is reduced. As a result, the temperature of the fixing belt 61 fails.

When the temperature of the fixing belt 61 in the non-sheet-passing area Fb is in the temperature range not lower than the magnetic permeability change start temperature, the magnetic field lines H are hardly induced into the temperature-sensitive magnetic member 64 in the non-sheet-passing area Fb as described above. Accordingly, the magnetic field lines H of the AC magnetic field, which is generated by the exciting coil 82, cross the conductive heating layer 612 of the fixing belt 61 in the thickness direction while diffusing. For this reason, the magnetic paths of the AC magnetic field, which is generated by the exciting coil 82, form a long loop, and the magnetic flux density on the magnetic paths passing through the conductive heating layer 612 of the fixing belt 61 is reduced. Accordingly, eddy current I generated in the conductive heating layer 612 of the fixing belt 61 is reduced in the non-sheet-passing area Fb where, for example, small-sized sheets P1 successively pass and temperature rises, so that the amount of heat (Joule heat W) generated in the non-sheet-passing area Fb of the fixing belt 61 is reduced. As a result, an excessive temperature rise in the non-sheet-passing area Fb is suppressed.

<Description of Structure Suppressing Temperature Rise of Temperature-Sensitive Magnetic Member>

In order to make the temperature-sensitive magnetic member 64 perform a function of suppressing an excessive temperature rise in the non-sheet-passing area Fb, the temperature of each area of the temperature-sensitive magnetic member 64 in the longitudinal direction needs to be changed according to the temperature of each area of the fixing belt 61, which faces each area of the temperature-sensitive magnetic member 64, in the longitudinal direction and the temperature-sensitive magnetic member 64 needs to perform a function as a detection section that detects the temperature of the fixing belt 61.

For this reason, a structure, which is hardly heated by electromagnetic induction with the magnetic field lines H, is employed for the temperature-sensitive magnetic member 64 itself. That is, even though the temperature of the fixing belt 61 is not higher than the magnetic permeability change start temperature and the temperature-sensitive magnetic member 64 is ferromagnetic, magnetic field lines H crossing the temperature-sensitive magnetic member 64 in the thickness direction exist among the magnetic field lines H generated from the IH heater 80. Accordingly, weak eddy current I is generated in the temperature-sensitive magnetic member 64, so that heat is slightly generated in the temperature-sensitive magnetic member 64 itself. For this reason, for example, when a lot of images are continuously formed, self-generated heat is accumulated in the temperature-sensitive magnetic member 64, so that the temperature of the temperature-sensitive magnetic member 64 tends to rise even in a sheet-passing area (see FIG. 10).

If self-generated heat caused by eddy-current loss is large as described above, the temperature of the temperature-sensitive magnetic member 64 rises and involuntarily reaches the magnetic permeability change start temperature. For this reason, most differences between the magnetic properties of a sheet-passing area and a non-sheet-passing area are lost, such that an effect of suppressing a temperature rise is not sufficiently obtained. Accordingly, Joule heat W, which is generated in the temperature-sensitive magnetic member 64 itself, needs to be suppressed to maintain a correspondence relationship between the temperature of the temperature-sensitive magnetic member 64 and the temperature of the fixing belt 61 and to make the temperature-sensitive magnetic member 64 accurately function as a detection section that detects the temperature of the fixing belt 61.

First, a material having properties (a specific resistance value and magnetic permeability), which make a material be hardly heated by electromagnetic induction with the magnetic field lines H, is selected as a material of the temperature-sensitive magnetic member 64 in order to reduce hysteresis loss or eddy-current loss in the temperature-sensitive magnetic member 64.

Second, the thickness of the temperature-sensitive magnetic member 64 is set to be larger than the surface depth when the temperature-sensitive magnetic member 64 is ferromagnetic so that magnetic field lines H hardly cross the temperature-sensitive magnetic member 64 in the thickness direction in the temperature range not higher than at least the magnetic permeability change start temperature.

Third, plural slits 64s, which divide the flow of the eddy current I generated by the magnetic field lines H, are formed at the temperature-sensitive magnetic member 64. Even though the material and thickness of the temperature-sensitive magnetic member 64 are selected so that the temperature-sensitive magnetic member 64 is hardly heated by electromagnetic induction, it is difficult to make the eddy current I, which is generated in the temperature-sensitive magnetic member 64, be zero. Accordingly, the flow of the eddy current I generated in the temperature-sensitive magnetic member 64 is divided by the plural slits 64s, such that the eddy current I is reduced. As a result, Joule heat W generated in the temperature-sensitive magnetic member 64 is reduced.

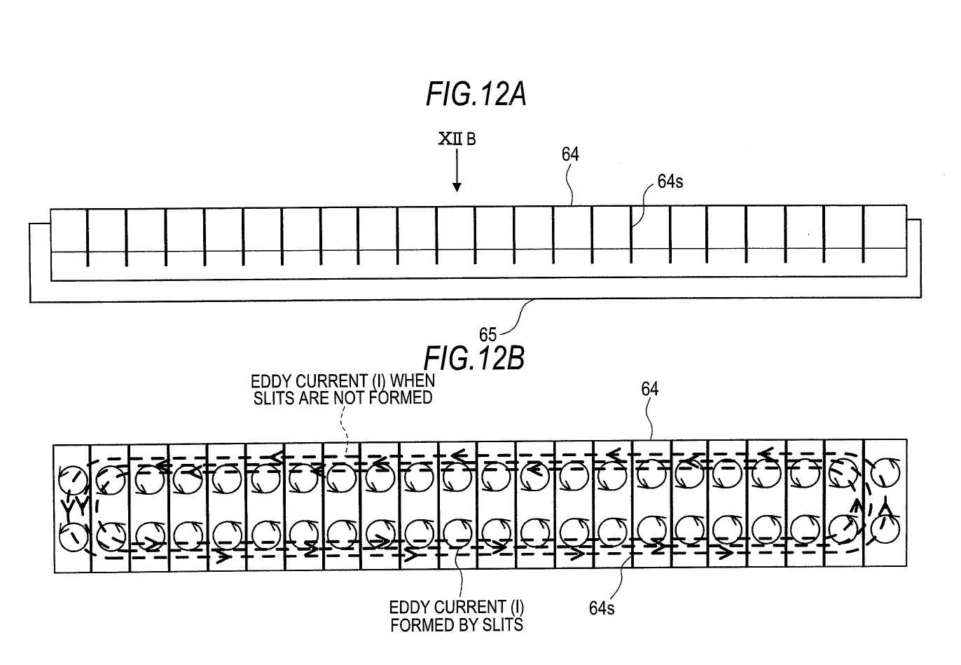

FIG. 12 is a view showing the slits that are formed at the temperature-sensitive magnetic member 64. FIG. 12A is a side view showing a state where the temperature-sensitive magnetic member 64 is installed on the holder 65, and FIG. 12B is a plan view of FIG. 12A as seen from above (the direction of an arrow XIIB). As shown in FIG. 12, the plural slits 64s are formed at the temperature-sensitive magnetic member 64 so as to be orthogonal to a direction where the eddy current I generated by the magnetic field lines H flows. For this reason, eddy current I (broken line in FIG. 12B), which flows in the shape of a large eddy over the entire longitudinal direction of the temperature-sensitive magnetic member 64 when the slits 64s are not formed, is divided by the slits 64s.

Accordingly, when the slits 64s are formed, eddy current I (solid line in FIG. 12B), which flows in the temperature-sensitive magnetic member 64, forms small eddies in areas between the slits 64s and the amount of eddy current I is reduced. As a result, the amount of heat (Joule heat W) generated in the temperature-sensitive magnetic member 64 is reduced, so that a structure where heat is hardly generated is realized. Therefore, the plural slits 64s function as eddy current dividing sections that divide eddy current I.

Meanwhile, the slits 64s have been formed at the temperature-sensitive magnetic member 64 exemplified in FIG. 12 so as to be orthogonal to a direction where eddy current I flows. However, for example, slits inclined with respect to the direction where eddy current I flows may be formed as long as the slits divide the flow of eddy current I. Further, slits may be formed at a part of the temperature-sensitive magnetic member 64 in the width direction other than the structure shown in FIG. 12 where the slits 64s are formed over the entire temperature-sensitive magnetic member 64 in the width direction. Further, the number, positions, and inclination angles and the like of the slits may be set according to the amount of heat generated in the temperature-sensitive magnetic member 64. Furthermore, a divided small-piece group where the temperature-sensitive magnetic member 64 is divided into small pieces at slit portions may be a state where the inclination angle of the slit is maximal, and the same effect as the effect of the invention is also obtained from these forms.

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention is defined by the following claims and their equivalents.

What is claimed is:

1. A fixing device comprising:
a belt-like member that is provided so as to circularly move;
a forming member that is disposed so as to come into contact with an outer peripheral surface of the belt-like member and forms a pressing portion, where a recording material is pressed, between the belt-like member and the forming member;
a contact member that comes into contact with the belt-like member;
a heating member that is positioned on a side more distant from the belt-like member as compared to the contact member, and heats the contact member;
a receiving member that is positioned on a side more distant from the belt-like member as compared to the heating member, and receives heat from the heating member; and
a heat transfer portion that is provided so as to be connected to the receiving member and the contact member, and transfers heat to the contact member from the receiving member.

2. The fixing device according to claim 1,
wherein a plurality of the heat transfer portions are provided, and
heat is transferred to a plurality of portions, of which positions are different from each other, of the contact member.

3. The fixing device according to claim 1,
wherein the heat transfer portion is formed integrally with the contact member or the receiving member.

4. The fixing device according to claim 1,
wherein the receiving member is disposed along a width direction of the belt-like member.

5. The fixing device according to claim 1,
wherein the heating member is provided so as to be movable relative to the contact member and the receiving member.

6. The fixing device according to claim 1,
wherein the heat transfer portion is disposed with a gap between the heating member and the heat transfer portion.

7. The fixing device according to claim 1,
wherein the receiving member is disposed so as to come into contact with a surface of the heating member that is positioned on a side of the heating member opposite to a surface of the heating member facing the contact member.

8. The fixing device according to claim 1,
wherein the contact member is a temperature-sensitive magnetic member.

9. The fixing device according to claim 1,
wherein the receiving member is a metal plate.

10. An image forming apparatus comprising:
an image forming section that forms images on a recording material;
a belt-like member that is provided so as to circularly move;
a forming member that is disposed so as to come into contact with an outer peripheral surface of the belt-like member, and forms a pressing portion, where a recording material on which images have been formed by the image forming section is pressed, between the belt-like member and the forming member;
a contact member that comes into contact with the belt-like member;
a heating member that is positioned on a side more distant from the belt-like member as compared to the contact member, and heats the contact member;
a receiving member that is positioned on a side more distant from the belt-like member as compared to the heating member, and receives heat from the heating member; and
a heat transfer portion that is provided so as to be connected to the receiving member and the contact member, and transfers heat to the contact member from the receiving member.
